(19) United States
(12) Patent Application Publication
(10) Pub. No.: US 2011/0277267 A1
(43) Pub. Date: Nov. 17, 2011

(54) ELECTRIC BLOWER AND ELECTRIC VACUUM CLEANER UTILIZING THE SAME

(75) Inventors: Kazushige Nakamura, Shiga (JP); Kazuhisa Morishita, Shiga (JP); Teppei Hidekuma, Shiga (JP); Hiroyuki Kayama, Osaka (JP); Tsuyoshi Nishimura, Shiga (JP)

(73) Assignee: PANASONIC CORPORATION, Kadoma-shi, Osaka (JP)

(21) Appl. No.: 13/145,978

(22) PCT Filed: Feb. 3, 2010
(86) PCT No.: PCT/JP2010/000633

§ 371 Date: Jul. 22, 2011

(30) Foreign Application Priority Data
Feb. 6, 2009 (JP) 2009-025740

(51) Int. Cl. B08B 5/04; F04B 35/04

(52) U.S. Cl. 15/300.1; 417/410.1

(57) ABSTRACT

Air guide (10) that rectifies air blown out from an impeller includes a plurality of guide vanes (80) having a circular arc shape. In a cross-sectional shape of each one of flow passages (81) of air guide (10), length B of a straight-line portion in a shaft direction of an inner wall-surface formed by one of guide vanes (80) on an outer peripheral side is small compared with length A of a straight-line portion in a shaft direction of an inner wall-surface formed by one of guide vanes (80) on an inner peripheral side. This provides a uniformed flow velocity distribution inside flow passages (81), resulting in a reduced loss caused by differences in flow velocity.

### TECHNICAL FIELD

The present invention relates to an electric blower and a vacuum cleaner using thereof.

### BACKGROUND ART

As a conventional electric blower, the electric blower disclosed in Patent Literature 1 is known, for example. FIG. 8 is a partially-cutaway cross-sectional view of the electric blower described in Patent Literature 1. Electric blower 119 includes motor section 132 and fan section 131.

Motor section 132 includes: armature 151 having shaft 153, armature core 170, and commutator 152. At an outer periphery of armature core 170, armature coil 122 is wound. In addition, motor section 132 includes magnetic field system 109 in which magnetic field winding 123 is wound at an outer periphery of magnetic field core 172. On both ends of shaft 153 of armature 151, axle-bearings 104 are press fitted. One of axle-bearings 104 is supported by anti-load side bracket 106. Moreover, motor section 132 includes brush holder 107 made of a metal, which houses carbon brush 108.

Fan section 131 includes: impeller 111 that sucks air serving as a load and blows out the sucked air as well, casing 112 that covers over impeller 111, load side bracket 105, and air guide 110 for rectifying the air. Impeller 111 is fixed to shaft 153 with a spacer (not shown), washer 114, and nut 115, and is integrally rotatable together with shaft 153. Note that the other axle-bearing 104 that is different from the one axle-bearing 104 supported by anti-load side bracket 106, is supported by load side bracket 105. Air guide 110 is fixed by screws (not shown) or the like between load side bracket 105 and impeller 111. And, air guide 110 has a plurality of guide vanes 180. Note that load side bracket 105 and anti-load side bracket 106 are fixed by screws (not shown) or the like.

Moreover, fan section 131 includes tight cap 116 made of a resin or the like. Tight cap 116 is fixed to a central portion of casing 112 by welding or the like to form suction port 190 of casing 112. An air-tightness is secured by contacting tight cap 116 with suction portion 191 of impeller 111.

Here, a description of an operation of electric blower 119 configured as described above will be given. The air blown out by rotating impeller 111 passes through air guide 110 for rectification. The air having passed through air guide 110 is conducted into motor section 132 to cool armature coil 122 and magnetic field winding 123, and then exhausted after passing through anti-load side bracket 106.

FIG. 9 is a partially-cutaway cross-sectional view of fan section 131 of electric blower 119. Arrows in FIG. 9 indicate an air stream. The air enters from suction portion 191 of impeller 111 and is blown out from impeller 111. The blown-out air passes through flow passages 181 configured of a plurality of guide vanes 180 of air guide 110. Thereby, the blown-out air is conducted to motor section 132, with the pressure of the air being gradually released to atmospheric pressure.

FIG. 10 is a cross-sectional view illustrating a part of air guide 110 and impeller 111 as viewed from above (the top side of FIG. 8) in the state where both are cut away in perpendicular to shaft 153. Through the rotation of impeller 111, a plurality of blades 182 of impeller 111 extrude the air toward an outer peripheral direction. This, in turn, allows fresh air to enter from suction portion 191 of impeller 111. The extruded air flows into flow passages 181 configured of guide vanes 180 of air guide 110 for rectification. Since the extruded air is pushed out toward a centrifugal direction by blades 182, the air intensively flows inside flow passages 181 along inner wall-surfaces 180b of guide vanes 180 of a circular arc shape, located on an outer peripheral side. Therefore, even within the same one of flow passages 181, a flow velocity of the air is smaller in proximity of inner wall-surface 180a of guide vane 180 on an inner peripheral side than that in proximity of inner wall-surface 180b of guide vane 180 on the outer peripheral side. That is, flow velocity distribution is such that the flow velocity becomes gradually small from inner wall-surface 180b of guide vane 180 on the outer peripheral side toward inner wall-surface 180a of guide vane 180 on the inner peripheral side.

FIG. 11 is a cross-sectional view taken along line 11-11 in FIG. 10, with casing 112 included as well. Here, the line 11-11 cross-section is taken by cutting along a plane including shaft 153. As indicated by an arrow in FIG. 11, the air is blown out from impeller 111 toward an outer periphery of impeller 111, at a slight downward incline. This is attributed to the form of front shroud 183 that forms a portion of impeller 111 on a suction portion 191 side. Front shroud 183 is of a circular truncated cone shape such that front shroud 183 has a steeper slope toward the top thereof and a gentler slope toward the bottom thereof. That is, since front shroud 183 has a slight inclination angle of α in proximity of an outer periphery thereof, the blown-out air is blow out toward the outer periphery thereof at the slight downward incline, as described above.

Flow passages 181 of air guide 110 are each such that flow passage bottom face 180c, i.e. a basal plane of the flow passage, is inclined downward toward an outer periphery thereof as shown in FIG. 11. That is, if all of guide vanes 180 were to be removed and all of flow passage bottom faces 180c were to be connected, the integrated bottom face would be of an umbrella-like shape having an incline downward toward the outer periphery. Besides, as another shape of flow passage 181, it is known that flow passage bottom faces 180c are not inclined but horizontal. That is, if all of guide vanes 180 were to be removed and all of flow passage bottom faces 180c were to be connected, the integrated bottom face would be of a disk-like shape horizontal and flat. With such shapes, their designing and fabrication of metal molds thereof are easy. Therefore, in conventional air guide 110, length B of a strait portion, in an shaft 153 direction, of inner wall-surface 180b of guide vane 180 on the outer peripheral side is equal to or larger than length A of a strait portion, in the shaft 153 direction, of inner wall-surface 180a of guide vane 180 on the inner peripheral side.

However, in conventional electric blower 119 described above, the flow velocity distribution of the air inside one of flow passages 181 of air guide 110 is such that the flow velocity is large toward inner wall-surface 180b of guide vane 180 on the outer peripheral side, as described using FIG. 10. And, as indicated by the arrow in FIG. 11, the air is blown out at the slight downward incline. For this reason, the flow velocity locally increases at a root portion, indicated by a black circle, located toward inner wall-surface 180b of guide vane 180 on the outer peripheral side, as shown in FIG. 11. Moreover, because flow passage bottom face 180c is horizontal and flat, or inclined downward toward the outer periphery, the air tends to more easily flow into the root portion located toward inner wall-surface 180b of guide vane 180 on the outer peripheral side, resulting in a local increase in the flow velocity. In this way, in an inside of the same one of flow passages 181, the presence of such a portion where the flow velocity is locally large (for example, the root portion indicated by the black circle in FIG. 11) causes a loss of air flow due to differences in flow velocity from other portions. For this reason, there has been a problem that suction performance of electric blower 119 is degraded.

### Patent Literature 1: Japanese Patent Unexamined Publication No. 2007-270633

### SUMMARY OF THE INVENTION

An object of the present invention is to resolve the problem described above in such a manner as follows. By means of optimization of a cross-sectional shape of each one of flow passages configured by guide vanes of an air guide, flow velocity distribution of air inside the flow passage is made uniform to suppress a loss caused by differences in flow velocity, thereby providing an electric blower with higher suction performance.

An electric blower according to the invention includes: a motor, an impeller having blades that are fixed to one end of a shaft of the motor and blow out the air toward an outer periphery thereof, and an air guide that rectifies the air blown out from the impeller. Moreover, the electric blower of the invention is such that the air guide has a plurality of guide vanes configuring flow passages, and the plurality of guide vanes are each of a circular arc shape when viewed from one end of the shaft. In addition, in the electric blower of the invention, a cross-sectional shape of each one of the flow passages when taken by cutting along a plane including the shaft is as follows. A length of a straight-line portion in a shaft direction of an inner wall-surface formed by one of the guide vanes on an outer peripheral side is small compared with a length of a straight-line portion in the shaft direction of an inner wall-surface formed by one of the guide vanes on an inner peripheral side.

With the configuration, in the inside of the flow passage of the air guide, the flow velocity distribution of the air is made uniform to reduce a loss caused by differences in flow velocity. Therefore, it is possible to provide an electric blower with high suction performance.

### BRIEF DESCRIPTION OF THE DRAWINGS

FIG. 1 is a partially-cutaway cross-sectional view of an electric blower according to a first embodiment of the present invention.

FIG. 2 is a cross-sectional view of an air guide and an impeller of the electric blower according to the embodiment.

FIG. 3 is a cross-sectional view taken along line 3-3 in FIG. 2.

FIG. 4 is a cross-sectional view of an air guide of an electric blower according to a second embodiment of the invention.

FIG. 5 is a cross-sectional view of an air guide of an electric blower according to a third embodiment of the invention.

FIG. 6 is a cross-sectional view of an air guide of an electric blower according to a fourth embodiment of the invention.

FIG. 7 is a configuration view of an electric vacuum cleaner according to a fifth embodiment of the invention.

FIG. 8 is a partial cross-section of a conventional electric blower.

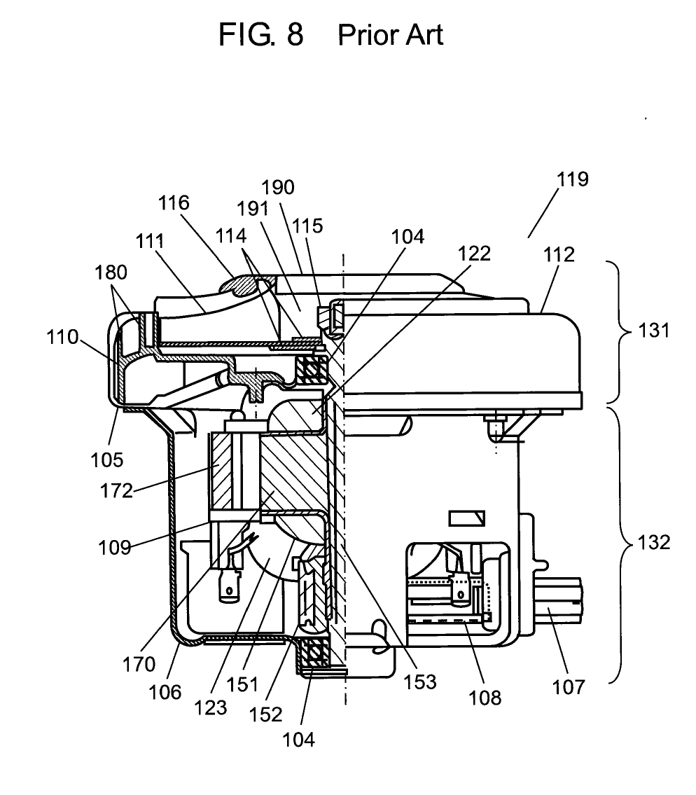

FIG. 9 is a partially-cutaway cross-sectional view of a fan section of the conventional electric blower.

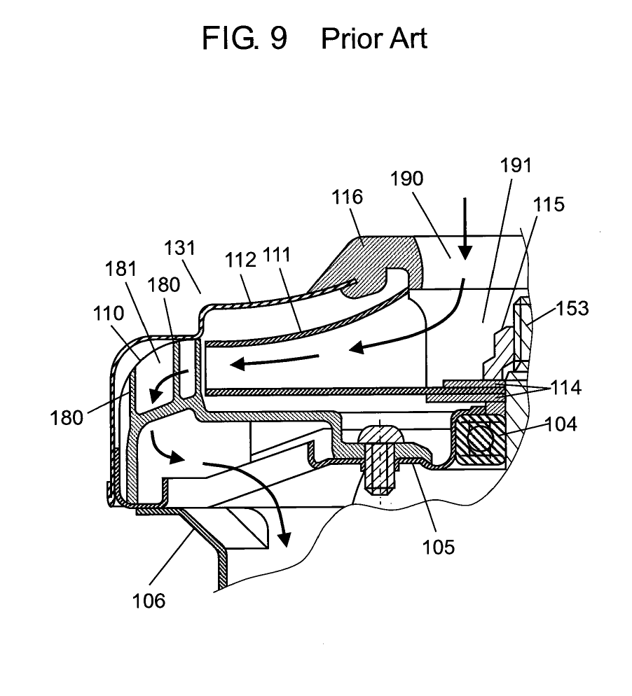

FIG. 10 is a cross-sectional view of an air guide and an impeller of the conventional electric blower.

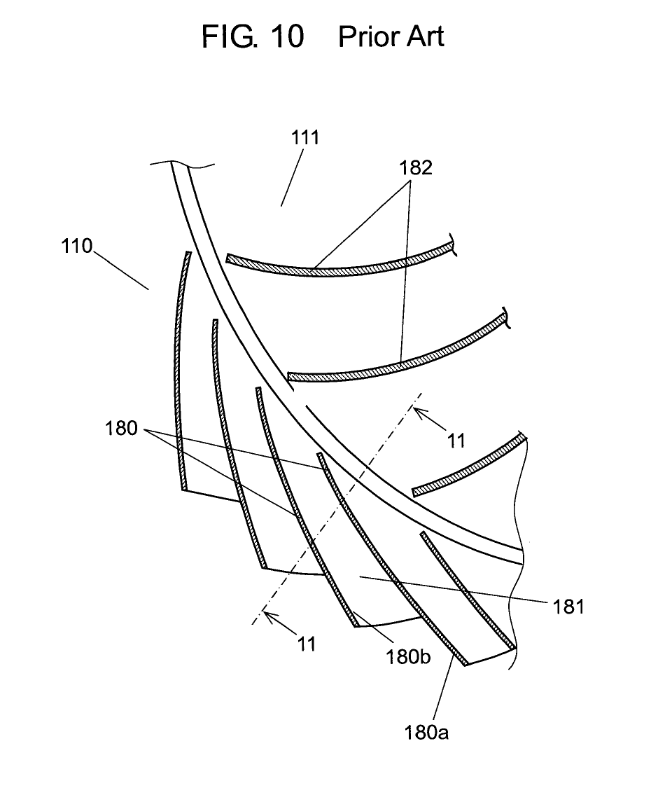

FIG. 11 is a cross-sectional view taken along line 11-11 in FIG. 10.

### DETAILED DESCRIPTION OF THE PREFERRED EMBODIMENTS

Hereinafter, embodiments of the present invention will be described with reference to the drawings.

### First Exemplary Embodiment

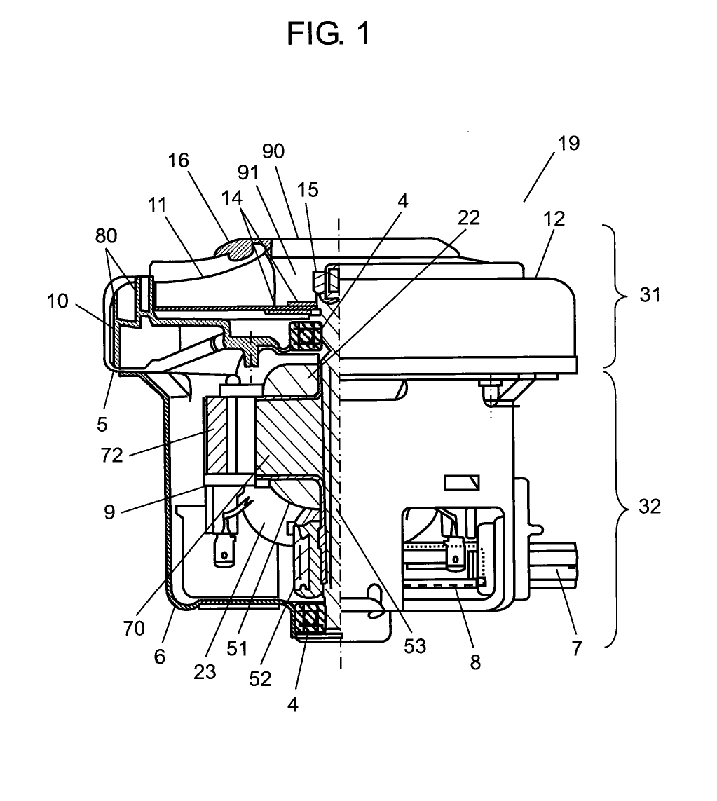

FIG. 1 is a partial cross-sectional view of a lateral side of an electric blower according to a first embodiment of the present invention. As shown in FIG. 1, electric blower 19 includes motor section 32 and fan section 31.

Motor section 32 includes armature 51 that has shaft 53, armature core 70, and commutator 52. At an outer periphery of armature core 70, armature coil 22 is wound. In addition, motor section 32 includes magnetic field system 9 in which magnetic field winding 23 is wound at an outer periphery of magnetic field core 72. On both ends of shaft 53 of armature 51, axle-bearings 4 are press fitted. One of axle-bearings 4 is supported by anti-load side bracket 6. Moreover, motor section 32 includes brush holder 7 made of a metal, which houses carbon brush 8.

Fan section 31 includes: impeller 11 that sucks in air, i.e. a load, and blows out the sucked air as well, casing 12 that covers over impeller 11, load side bracket 5, and air guide 10 for rectifying the air. Impeller 11 is fixed to shaft 53 with a spacer (not shown), washer 14, and nut 15, and is integrally rotatable together with shaft 53. Note that the other axle-bearing 4 that is different from the one axle-bearing 4 supported by anti-load side bracket 6, is supported by load side bracket 5. Air guide 10 is fixed by screws (not shown) or the like between load side bracket 5 and impeller 11. And, air guide 10 has a plurality of guide vanes 80. Note that load side bracket 5 and anti-load side bracket 6 are fixed by screws (not shown) or the like.

Moreover, fan section 31 includes tight cap 16 made of a resin or the like. Tight cap 16 is fixed to a central portion of casing 12 by welding or the like. Tight cap 16 is open at the central portion thereof to form suction port 90 of casing 12. An air-tightness is secured by contacting tight cap 16 with suction portion 91 of impeller 11.

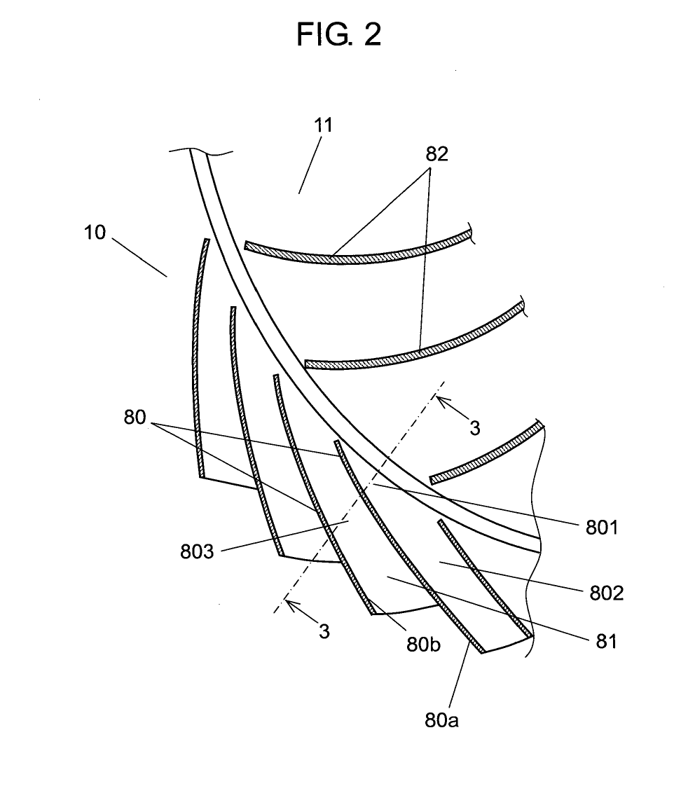

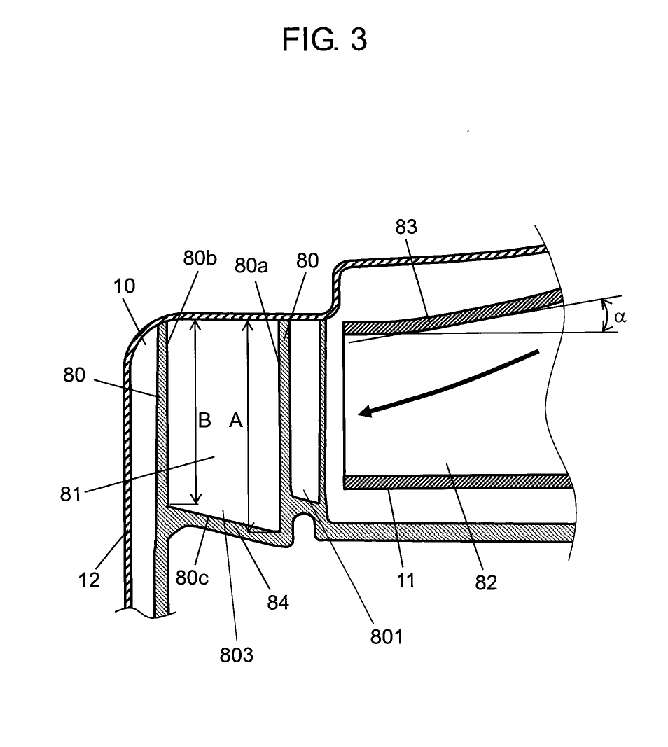

FIG. 2 is a cross-sectional view illustrating a part of air guide 10 and impeller 11 as viewed from above (the top side of FIG. 1) in the state where both are cut away in perpendicular to shaft 53. FIG. 3 is a cross-sectional view taken along line 3-3 in FIG. 2, with casing 12 included as well. Here, the line 3-3 cross-section is taken by cutting along a plane including shaft 53.

As shown in FIG. 3, air guide 10 includes a plurality of guide vanes 80 on base portion 84. Guide vanes 80 are each of a circular arc shape when viewed from above, as shown in FIG. 2. And, all of guide vanes 80 have the same shape. Each one of flow passages 81 is configured by being surrounded with two adjacent guide vanes 80, base portion 84, and casing 12. Note that, a face of base portion 84, which forms the basal plane of flow passage 81, is flow passage bottom face 80c.

As shown in FIG. 3, flow passage bottom face 80c is substantially-linearly inclined upward from an inner periphery thereof toward an outer periphery thereof. That is, if all of guide vanes 80 were to be removed and all of flow passage bottom faces 80c were to be connected, the integrated bottom face would be of a substantially inverted-umbrella like shape having an incline upward toward around the outer periphery. With this configuration, length B of a straight-line portion in a shaft 53 direction of inner wall-surface 80b of guide vane 80 on an outer peripheral side is small compared with length A of a straight-line portion in the shaft 53 direction of inner wall-surface 80a of guide vane 80 on an inner peripheral side.

Here, a description will be made of an operation of electric blower 19 configured as described above. When electric blower 19 is started up, the rotation of shaft 53 of motor section 32 causes impeller 11 to rotate. Rotating impeller 11 causes the air to be sucked in from suction portion 91. The sucked-in air flows along blades 82 and then is blown out. In this case, as indicated by an arrow in FIG. 3, the sucked-in air is blown out at a slight downward incline toward an outer periphery of impeller 11. This is attributed to the form of front shroud 83 that forms a portion of impeller 11 on a suction portion 91 side. Front shroud 83 is of a circular truncated cone shape such that front shroud 83 has a steeper slope toward the top thereof and a gentler slope toward the bottom thereof. That is, since front shroud 83 has a slight inclination angle of α in proximity of an outer periphery thereof, the sucked-in air is blown out toward the outer periphery thereof at the slight downward incline, as described above.

The blown-out air flows into an upper portion of flow passage 81 of air guide 10 for rectification. The air having flowed into air guide 10 proceeds through flow passage 81 along the shape of guide vanes 80 to flow toward downstream flow passage 81. Here, as shown in FIG. 2, the position of bottom portion 802 located at downstream bottom portion 801 of flow passage 81 corresponds, in the next flow passage 81, to the position of bottom portion 803. As shown in FIG. 3, flow passage 81 becomes large downward toward a downstream side thereof such that bottom portion 803 is positioned lower than bottom portion 801. That is, flow passage 81 is configured such that the flow passage cross-sectional area becomes gradually large from upstream to downstream. With this configuration, the air that flows inside flow passage 81 decelerates gradually. That is, flow-velocity energy of the air flowing inside flow passage 81 is gradually converted into pressure energy, which results in an increase in suction pressure of impeller 11.

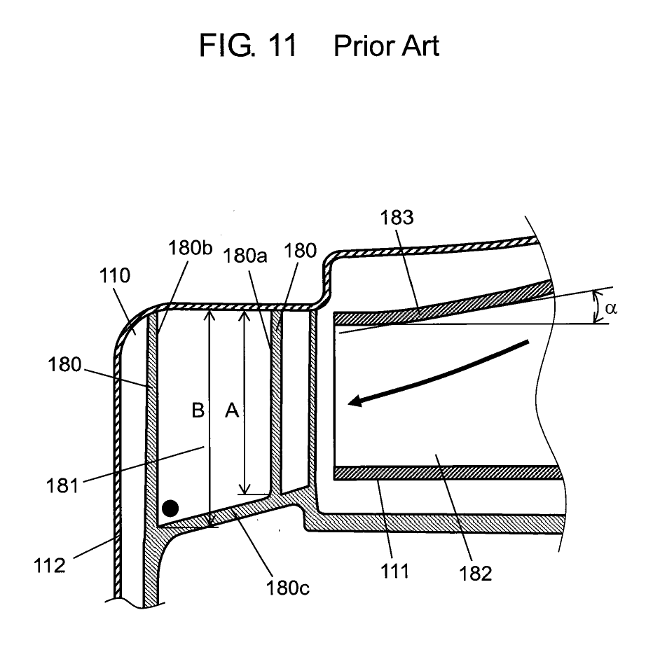

Here, in conventional air guide 110, there exists a portion (a black circle) where the flow velocity is large in the inside of flow passage 181, as shown in FIG. 11. In contrast, as shown in FIG. 3, in air guide 10 according to the embodiment, length B of the straight-line portion in the shaft 53 direction of inner wall-surface 80b of guide vane 80 on the outer peripheral side is small compared with length A of the straight-line portion in the shaft 53 direction of inner wall-surface 80a of guide vane 80 on the inner peripheral side. That is, by narrowing a space at an outer peripheral portion where the flow velocity is large in the case of conventional air guide 110, a space at an inner peripheral portion where the flow velocity is small in the case of conventional air guide 110, becomes relatively wide. Accordingly, at the inner peripheral portion where the space becomes relatively wide, the air becomes easy to flow, resulting in a uniform flow velocity inside flow passage 81. This reduces a loss, in the inside of flow passage 81, caused by differences in flow velocity between portions where the flow velocities are large and small.

### Second Exemplary Embodiment

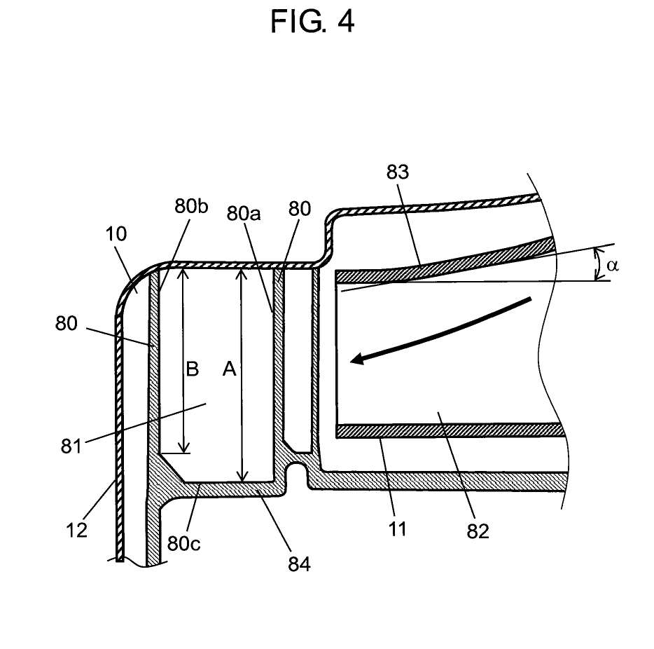

FIG. 4 is a cross-sectional view of around an impeller and an air guide of an electric blower according to a second embodiment of the invention. The embodiment is different from the first embodiment in terms of shapes of: base portion 84; flow passage bottom face 80c of flow passage 81; inner wall-surface 80b of guide vane 80 on the outer peripheral side; and a coupling portion of flow passage bottom face 80c with inner wall-surface 80b of guide vane 80 on the outer peripheral side, of the first embodiment. The other constitutions are the same as those of the first embodiment. The same constitutional elements are designated by the same numerals and symbols, and a detailed explanation thereof is omitted.

As shown in FIG. 4, flow passage bottom face 80c of air guide 10 according to the embodiment is a horizontal and flat face. Note that the horizontal and flat face is a face perpendicular to shaft 53. In accordance with the shape of flow passage bottom face 80c, base portion 84 has a horizontal and flat shape as well. Here, the coupling portion of flow passage bottom face 80c with inner wall-surface 80b of guide vane 80 on the outer peripheral side, has a chamfered corner (C-face) forming an angle of approximately 45 degrees.

With this configuration, length B of a straight-line portion in the shaft 53 direction of inner wall-surface 80b of guide vane 80 on the outer peripheral side is small compared with length A of a straight-line portion in the shaft 53 direction of inner wall-surface 80a of guide vane 80 on the inner peripheral side. That is, by narrowing the space at the outer peripheral portion where the flow velocity is large in the case of conventional air guide 110, the space at the inner peripheral portion where the flow velocity is small in the case of conventional air guide 110, becomes relatively wide. Accordingly, at the inner peripheral portion where the space becomes relatively wide, the air becomes easy to flow, resulting in a uniform flow velocity inside flow passage 81. As a result, this reduces a loss, in the inside of flow passage 81, caused by differences in flow velocity between portions where the flow velocities are large and small. Moreover, by filling to eliminate an internal corner portion inside flow passage 81 where the flow velocity is large in the case of the conventional air guide, the loss is reduced.

### Third Exemplary Embodiment

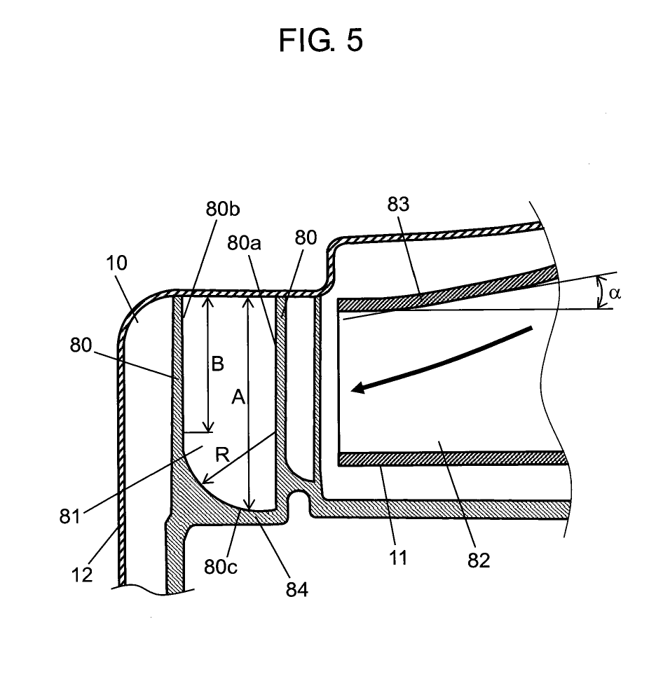

FIG. 5 is a cross-sectional view of around an impeller and an air guide of an electric blower according to a third embodiment of the invention. The embodiment is different from the second embodiment in terms of a shape of the coupling portion of flow passage bottom face 80c with inner wall-surface 80b of guide vane 80 on the outer peripheral side of the second embodiment. The other constitutions are the same as those of the second embodiment. The same constitutional elements are designated by the same numerals and symbols, and a detailed explanation thereof is omitted.

As shown in FIG. 5, in air guide 10 according to the embodiment, the coupling portion of flow passage bottom face 80c with inner wall-surface 80b of guide vane 80 on the outer peripheral side, has a circular arc shape having radius R. Radius R is equal to a width of flow passage 81.

With this configuration, length B of a straight-line portion in the shaft 53 direction of inner wall-surface 80b of guide vane 80 on the outer peripheral side is small compared with length A of a straight-line portion in the shaft 53 direction of inner wall-surface 80a of guide vane 80 on the inner peripheral side. That is, by narrowing the space at the outer peripheral portion where the flow velocity is large in the case of conventional air guide 110, the space at the inner peripheral portion where the flow velocity is small in the case of conventional air guide 110, becomes relatively wide. Accordingly, at the inner peripheral portion where the space becomes relatively wide, the air becomes easy to flow, resulting in a uniform flow velocity inside flow passage 81. As a result, this reduces a loss, in the inside of flow passage 81, caused by differences in flow velocity between portions where the flow velocities are large and small. Moreover, acuteness of the corner portion inside flow passage 81 is reduced where the flow velocity is large in the case of the conventional air guide, which thereby reduces the loss of air flow.

### Fourth Exemplary Embodiment

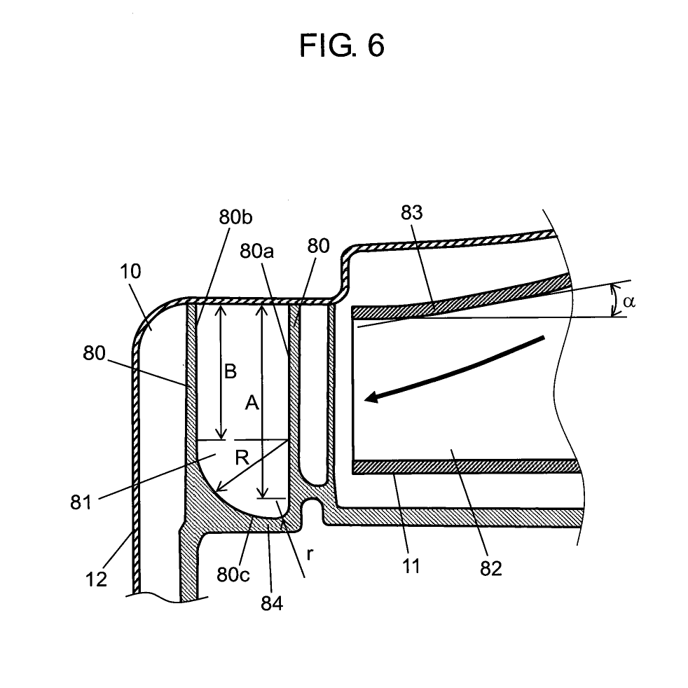

FIG. 6 is a cross-sectional view of around an impeller and an air guide of an electric blower according to a fourth embodiment of the invention. The embodiment is different from the third embodiment in terms of a shape of the coupling portion of flow passage bottom face 80c with inner wall-surface 80a of guide vane 80 on the inner peripheral side in flow passage 81 of the third embodiment. The other constitutions are the same as those of the third embodiment. The same constitutional elements are designated by the same numerals and symbols, and a detailed explanation thereof is omitted.

As shown in FIG. 6, in air guide 10 according to the embodiment, the coupling portion of flow passage bottom face 80c with inner wall-surface 80a of guide vane 80 on the inner peripheral side, has a circular arc shape having radius “r”. Radius “r” is smaller than the width of flow passage 81, i.e. radius “r” is smaller than radius R.

With this configuration, length B of a straight-line portion in the shaft 53 direction of inner wall-surface 80b of guide vane 80 on the outer peripheral side is small compared with length A of a straight-line portion in the shaft 53 direction of inner wall-surface 80a of guide vane 80 on the inner peripheral side. That is, by narrowing the space at the outer peripheral portion where the flow velocity is large in the case of conventional air guide 110, the space at the inner peripheral portion where the flow velocity is small in the case of conventional air guide 110, becomes relatively wide. Accordingly, at the inner peripheral portion where the space becomes relatively wide, the air becomes easy to flow, resulting in a uniform flow velocity inside flow passage 81. As a result, this reduces a loss, in the inside of flow passage 81, caused by differences in flow velocity between portions where the flow velocities are large and small. Moreover, the acuteness of corner portions inside flow passage 81 is further reduced where the flow velocity is large in the case of the conventional air guide, which thereby reduces the loss of air flow.

### Fifth Exemplary Embodiment

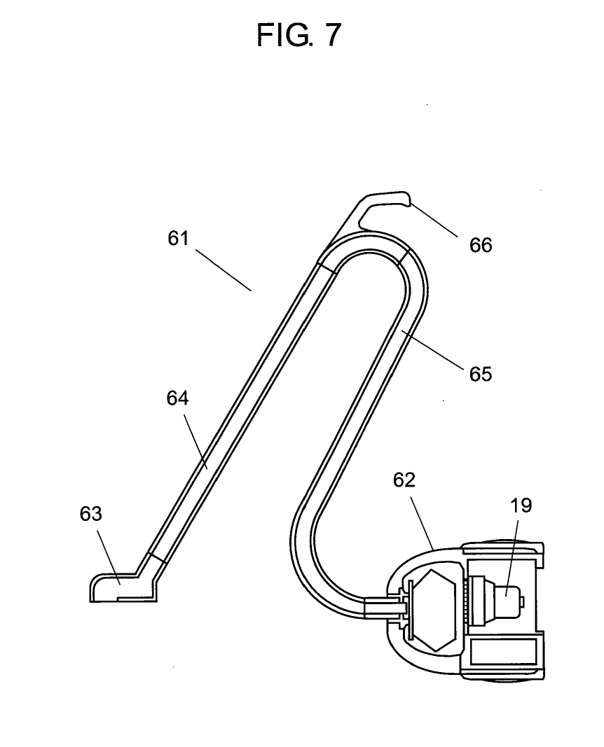

FIG. 7 is a configuration view of an electric vacuum cleaner according to a fifth embodiment of the invention. Electric vacuum cleaner 61 includes: vacuum cleaner body 62, nozzle 63 sucking dust and the like, pipe 64 coupled with one end of nozzle 63, and hose 65 coupling pipe 64 with vacuum cleaner body 62. Vacuum cleaner body 62 is provided with any one of electric blowers 19 according to embodiments 1 to 4. A remote switch is disposed at gripper 65 of pipe 64. By using the remote switch, electric blower 19 is started up. In this embodiment, electric blower 19 is designed to reduce a loss of air flow by means of the configuration of air guide 10, which thereby improves suction performance of electric vacuum cleaner 61.

### INDUSTRIAL APPLICABILITY

Since electrical blowers according to the present invention can provide a reduced loss of air flow inside air guides thereof and improved air-suction performance thereof, they are capable of being used for electric vacuum cleaners, in particular handy ones that require a reduced size and weight.

### REFERENCE MARKS IN THE DRAWINGS

10 air guide

11 impeller

19 electric blower

32 motor section

53 shaft

61 electric vacuum cleaner

80 guide vane

80a inner wall-surface of a guide vane on an inner peripheral side (inner wall-surface formed by a guide vane located on an inner peripheral side)

80b inner wall-surface of a guide vane on an outer peripheral side (inner wall-surface formed by a guide vane located on an outer peripheral side)

80c flow passage bottom face (basal plane)

81 flow passage

82 blade

91 suction portion

1. An electric blower comprising:
a motor section;
an impeller including blades fixed to one end of a shaft of the motor section, the blades blowing out air in an outer peripheral direction thereof; and
an air guide rectifying the air blown out from the impeller,
wherein
the air guide includes a plurality of guide vanes forming flow passages,
each of the plurality of guide vanes has a circular arc shape when viewed from the one end of the shaft, and
a bottom face of each one of the flow passages is configured to be inclined upwardly from an inner peripheral side to an outer peripheral side so that a length of a straight-line portion, in a direction of the shaft, of an inner wall-surface formed by one of the guide vanes located on the outer peripheral side is small compared with a length of a straight-line portion, in the direction of the shaft, of the inner wall-surface formed by the one of the guide vanes located on the inner peripheral side, with a cross-sectional shape taken by cutting along a plane including the shaft.

2. The electric blower according to claim 1, wherein, in the cross-sectional shape of the flow passage, the bottom face of the flow passage is of a straight line.

3. (canceled)

4. The electric blower according to claim 1, wherein, in the cross-sectional shape of the flow passage, a coupling portion of the bottom face of the flow passage with the inner wall-surface formed by the guide vane located on the outer peripheral side is of a circular arc shape having a radius equal to a length of a width of the flow passage.

5. The electric blower according to claim 4, wherein, in the cross-sectional shape of the flow passage, a coupling portion of the bottom face of the flow passage with the inner wall-surface formed by the guide vane located on the inner peripheral side is of a circular arc shape having a radius smaller than the length of a width of the flow passage.

6. An electric vacuum cleaner comprising the electric blower according to claim 1.

7. An electric vacuum cleaner comprising the electric blower according to claim 2.

8. An electric vacuum cleaner comprising the electric blower according to claim 4.

9. An electric vacuum cleaner comprising the electric blower according to claim 5.
